(19) United States
(12) Patent Application Publication
(10) Pub. No.: US 2007/0029349 A1
(43) Pub. Date: Feb. 8, 2007

(54) Multiple size-receiving toothpaste dispenser

(76) Inventor: Jeffrey D. Glen, Bala Cynwyd, PA (US)

Correspondence Address: Kenneth P. Glynn, 24 Mine Street, Flemington, NJ, 08822, US

(21) Appl. No.: 11/378,733

(22) Filed: Mar. 17, 2006

Related U.S. Application Data
(63) Continuation-in-part of application No. 11/198,631, filed on Aug. 5, 2005.

(51) Int. Cl. B67D 5/40

(52) U.S. Cl. 222/372

(57) ABSTRACT

A toothpaste dispenser device has an upright elongated main housing base having a bottom and at least one side wall, and having and a tube insert opening for inserting a tube therein, and a dispensing outlet located on the side wall. A male receiving inlet stem is adapted for receiving the inside neck of an inverted, uncapped toothpaste tube thereon and has a plurality of different outside diameters in an increasing size with descending position, capable of receiving a plurality of different size tube necks with different inside diameters. A dispensing conduit and one way valves are functionally connected to the inlet and to the outlet, and a spring-biased push rod is provided for pumping.

### REFERENCES TO RELATED APPLICATIONS

This application is a continuation in part of copending U.S. patent application Ser. No. 11/198,631, filed on Aug. 5, 2005, and entitled “Toothpaste Dispenser Device”, by the inventor herein.

### BACKGROUND OF THE INVENTION

1. Field of the Invention

The present invention relates to toothpaste and similar viscous product dispensing, and more particularly to a stand up device that receives a toothpaste tube, wherein pushing on a lever against a spring creates reciprocal motion that dispenses toothpaste and reloads the device for the next dispensing by removal of paste from the tube via suction. The device includes a male receiving stem that inserts into a toothpaste or similar tube and is adapted to receive a plurality of tubes with necks having different inside diameters, e.g., different size tubes. Thus, the present invention device provides an attractive bathroom accessory that sits on a sink, table or shelf and includes dispensing means to more steadily, efficiently and economically dispense the toothpaste product from its original container. Hence, a tube of toothpaste or similar container is fitted into the present invention device and a pump action sucks toothpaste out and dispenses it with the aide of critical one way valving. The present invention toothpaste dispenser device is easily fabricated from metal, plastic, other materials or combinations thereof.

2. Information Disclosure Statement

The following patents represent the state of the art of prior toothpaste and related dispensers:

U.S. Pat. No. 6,851,577 describes a dispenser configured to receive a collapsible container and provided with a slider linearly guided along the collapsible container to uniformly press thereagainst to advance a substance contained in the collapsible towards and discharge in through the container's outlet port at a uniform rate.

U.S. Pat. No. 6,789,701 describes a dispenser which includes a base into which the open end of a conventional tube of toothpaste is threaded, a manually operated pump in the base to draw paste from the tube and discharge the paste onto a toothbrush, a perforated tube positioned in the tube of toothpaste to prevent prematurely collapsing of the walls and resulting flow restriction as paste is drawn from the tube, and a cover that hinges to the top of the base to conceal the tube and that provides presentation area for advertising, logos and other graphic or written information.

U.S. Pat. No. 6,454,133 describes an apparatus to provide discharging toothpaste from a toothpaste tube under control of a user. The apparatus includes a tube holder and a tube receptacle disposed within a first end of the tube holder and adapted to accept a cap end of the toothpaste tube. The apparatus further includes a set of nip rolls adapted to engage a body of the toothpaste tube and to urge toothpaste from a distal end of the toothpaste tube towards the cap end and a wheeled trolley coupled to the nip rolls on a first end and engaging a guide channel of the tube holder on a second end and adapted to maintain an alignment of the nip rolls with respect to a centerline of the tooth paste tube as the nip rolls travel along a longitudinal axis of the toothpaste tube from the distal end to the cap end.

U.S. Pat. No. 5,305,922 describes a dispenser that is disclosed herein having a paste container removably mounted in a stationary base with a dispensing nozzle for discharging pate therethrough. In one version, the paste container is pressurized by use of a removable air pump while in another version, a mechanical pump extracts paste into and through the nozzle. In either version, a brush-operated lever actuates a mechanism coupled to the nozzle for selectively releasing the pressurized paste.

U.S. Pat. No. 5,845,813 describes a wall mountable toothpaste dispenser operated by electrical power from the bathroom outlet or batteries. A sliding horizontal cylindrical wedge presses a toothpaste tube against a fixed vertical planar wedge with an inclined surface for squeezing a dose onto a toothbrush. The cylindrical wedge is moved by a line and pulley system driven by a motor and spur gearing. The dispenser is made from inexpensive materials and any mechanical part can be repaired by the user. Other viscous liquid products can be dispensed by this device.

U.S. Pat. No. 5,884,812 describes an economical and ergonomical three-part tube squeezer for collapsible tubes containing viscous fluids, the squeezer including an elliptically shaped housing, a shaft rotatably mounted in the housing and having a longitudinal slot therethrough to receive the end of a tube and wind the tube therearound, a key outside the housing on an end of the shaft, for winding the shaft, and a removable (friction-fit or threaded) locking piece on the other end of the shaft, outside the housing, for holding the structure in assembly. The tube squeezer is self-standing and operated while in the standing position or held in one's hand. The tube squeezer rolls up the collapsible tube by the key to dispense the viscous fluid contents upwardly when in the standing position. The tube squeezer can be disposed when the collapsible tube or reused with another tube.

U.S. Pat. No. 4,805,805 describes a tube dispenser which utilizes a ratchet actuated pusher for squeezing the contents from a tube. In a first embodiment, a tube is supported on a support plate with a nozzle of the tube extending through an aperture formed in an end wall connected to the support plate. A handle, mounted on an opposite end wall, has an attached ratchet actuation lever. A toothed rod extends through an aperture in the end wall adjacent the handle. A pair of frame rods extend between the end walls. By squeezing the ratchet actuation lever, the pusher is caused to advance along the support plate, squeezing the tube walls between the pusher and the support plate. Three different configurations of the pusher are disclosed. The pusher may be formed as a cylindrical bar, a right angle channel, or as a plurality of rotatable rollers. In a second embodiment, the tube is supported within a receptacle, with a nozzle of the tube extending through an aperture in an end wall of the receptacle. A plurality of rotatable rollers are mounted in a triangular configuration for sliding movement along a partition floor of the receptacle. A squeezing slot is formed between the rollers. A toothed bar in conjunction with a ratchet lever are utilized to advance the rollers along the partition floor of the receptacle, thus dispensing the tube contents.

U.S. Pat. No. 4,570,829 describes a toothpaste dispenser that is constructed in the form of a wall unit simulating a toothbrush with an elongate upper compartment for receiving an inverted toothpaste tube and constituting the toothbrush handle portion, and a lower compartment constituting the bristle portion of the toothbrush and containing a dispenser mechanism. The dispenser mechanism comprises a resilient dispensing duct which receives toothpaste from the inverted tube, and a lever-operated plunger for pumping paste through the tube and discharging same through an outlet nozzle. A metered quantity of paste is dispensed with each forward stroke of the lever.

U.S. Pat. No. 4,548,337 describes a dispenser apparatus for dispensing a portion of the contents from compressible tubular containers such as those used for toothpaste includes a plastic housing member having one portion designed for the receipt of an air pressure pump and associated linkage, and a second outward portion in communication with the air pressure pump but otherwise sealed, and a front panel portion hinged to the remainder of the housing for selectively opening and closing the second outward portion so as to define a sealed chamber. A tubular container such as a toothpaste tube is placed in the sealed chamber. The bottom surface or wall of the housing includes an internally threaded outlet which is rigidly secured to the housing and which is suitable designed to receive the threaded end of the tubular container such that when one tube is empty, it may be unscrewed and a new tube screwed into this outlet. A mechanical linkage connects the air pressure pump to an exterior pushbutton control and the connecting linkage also cooperates with a pulley arrangement to selectively open and close a slide valve disposed over the outlet such that as the air pressure pump is activated the valve is opened and when the air pressure pump is deactivated, the valve closes.

U.S. Pat. No. 4,418,840 describes an invention that is directed to a dispenser for housing and dispensing on demand a predetermined amount of the semi-fluid contents of a compressible tube container, such as a toothpaste tube. The dispenser for automatically dispensing a semi-fluid material that can be caused to flow slowly from a compressible tube comprises:

(a) a structure for holding the tube in a position such that the opening in the tube extends downwardly;

(b) an arrangement for slidably closing the end of the opening in the tube;

(c) a device for agitating upon manual command the tube and semi-fluid contents such that the contents are induced to flow;

(d) the above recited arrangement withdrawing the slidable closure from the opening upon manual command to thereby permit the material to flow gradually out of the tube.

U.S. Pat. No. 4,331,265 describes a dispenser that progressively empties a tube from one end by applying pressure to the other end. The dispenser comprises a support on which the tube rests. A handle is pivotally mounted on the support and has a range of reciprocating movement between first and second pre-determined points for applying an increment of pressure to one end of the tube. A ratchet is connected to the handle and permits the roller to move incrementally forward against the tube exerting pressure thereon during each reciprocation. As the handle moves between the first and second pre-determined points, it moves to an intermediate point defined relative to the point where the handle is pivotally mounted on the support and beyond the point to an over-center position where the roller releases sufficient pressure on the contents of the tube to prevent residual emptying or dripping.

U.S. Pat. No. 4,303,110 describes a dispenser for drawing toothpaste from a squeeze-tube container and applying it to the top of a toothbrush with a vacuum pump of piston-cylinder construction which is so operated that the pump draws the toothpaste out of the squeeze-tube container when the toothbrush is pushed into the dispenser and discharges the same when the toothbrush is withdrawn. The toothbrush is pumped through a passage which is provided with an inlet valve which operates in cooperation with an elastic adapter used for mounting and sealing the neck portion of the squeeze-tube container, an outlet valve which operates in cooperation with a port formed in the cylinder, and an elastic discharge nozzle which opens when the toothpaste is being pumped and closes by its own resiliency when the toothpaste is being drawn out of the squeeze-tube container. The amount of toothpaste supplied each time by the dispenser can be adjustably predetermined as desired.

U.S. Pat. No. 4,258,864 describes an automatic toothpaste dispenser employs a roller-type squeeze device that is driven along the toothpaste tube simultaneously with the opening of a gate that permits the toothpaste to flow. After the desired amount of toothpaste has been dispensed, the roller is automatically retracted and the gate is simultaneously closed. However, the retraction of the gate only continues until the gate is closed, which results in a ratchet-like effect, the roller being retracted a smaller distance than that by which it is advanced.

U.S. Pat. No. 3,946,904 describes a dispenser for paste or viscous liquid in tubes, which may be either counter or wall mounted. A pair of cooperating rollers having a set of central meshing teeth are adapted to receive a tube. The rollers are mounted in a supporting bracket adapted to slide within a case. The case comprises two identically configured portions which are hinged together, and are provided with locking means to contain the bracket, and tube in position therewithin. Rotation of a projecting knob causes the contents of the tube to be dispensed. The provision of projecting teeth on the cooperating rollers ensures the elimination of any possibility of slippage or jamming of the tube.

Notwithstanding the prior art, the present invention is neither taught nor rendered obvious thereby.

### SUMMARY OF THE INVENTION

The present invention is a toothpaste dispenser device that includes an upright elongated main housing base having a bottom and at least one side wall, and having and a tube insert opening for inserting a tube therein, and having a dispensing outlet located on the side wall. The main housing base may be flat for placement on a horizontal surface, such as a sink, or may have a different shape and could be a wall mount unit.

The present invention device also includes a male receiving inlet stem adapted for receiving the inside neck of an inverted, uncapped toothpaste tube thereon. The inlet stem is fixedly located in the main housing base and is functionally connected to the dispensing outlet via a dispensing conduit. In preferred embodiments, the inlet stem has a plurality of different outside diameters in an increasing size with descending position arrangement so as to be capable of receiving a plurality of different size tube necks with corresponding different inside diameters.

There is also a cover for opening and closing the tube insert opening of the base, as well as a dispensing conduit functionally connected to the inlet and to the outlet, and having a push rod orifice located thereon.

The present invention device further includes a spring-biased push rod located in the conduit push rod orifice and extending therefrom to a point outside of the main housing base and cover. There is a spring biasing it to a rest position away from the inlet stem. The push rod has a downstroke and an upstroke, wherein the push rod may be pushed down in its downstroke against the bias of the spring to a maximum stress position, and released to move up by the force of the spring in an upstroke back to its rest position.

A first one-way valve is located in the conduit near the inlet stem that permits flow of toothpaste from a connected tube when the push rod is in an upstroke and prevents flow of toothpaste from the tube when the push rod is in its rest position or in its downstroke. A second one-way valve is located in the conduit near the outlet that permits flow of toothpaste from the conduit through the outlet when the push rod is in a downstroke and prevents flow of toothpaste from the conduit when the push rod is in its rest position or in its upstroke.

In some preferred embodiments, the inlet stem is tapered with a smallest diameter at its top of said taper and a largest diameter at its bottom of said taper. In other preferred embodiments, the inlet stem includes a plurality of different diameter rings with a smallest diameter at its top of said taper and a largest diameter at its bottom of said taper.

In some preferred embodiment, the main housing base and the main housing cover have a closed position top view shape selected from the group consisting of a square, a polygon, a rectangle, a circle and an oval.

In some embodiments, the toothpaste dispenser device push rod extends through the cover.

In some embodiments of the toothpaste dispenser device, push rod is positioned vertically and is at a right angle to the base bottom. In some embodiments, the push rod has a top area for pushing downwardly thereon. In some embodiments, the push rod has a side slider button for pushing downwardly thereon.

In some preferred embodiments, the toothpaste dispenser device dispensing outlet has a closing mechanism that is biased in a closed position and yields to open when the push rod is depressed and the toothpaste is being dispensed therefrom.

For extra durability and strength, in some embodiments the main housing base includes a push rod guide located on an inside of its side wall to maintain the push rod in a single axis for its upstroke and downstroke movement.

The spring may be a coil spring connected to the push rod at a first end and is fixedly attached to the base at a second end.

In some embodiments, the toothpaste dispenser device also includes an uncapped tube of toothpaste screwed into the inlet.

In some embodiments, the main housing base and the main housing cover have a closed position top view shape selected from the group consisting of a square, a polygon, a rectangle, a circle and an oval. However, other shapers, symmetric or non-symmetric, could also be used. One alternative would be to combine a flat bottomed base device with orifices, eyelets, or other attachment means for screwing, hanging or attaching to a wall. In other embodiments, the consumer would have the choice to wall mount or rest the device on a countertop or other horizontal surface.

### BRIEF DESCRIPTION OF THE DRAWINGS

The present invention should be more fully understood when the specification herein is taken in conjunction with the drawings appended hereto wherein:

FIG. 1 illustrates a cut side view of a present invention toothpaste dispenser device;

FIG. 2 illustrates a partial detailed side cut front view of the present invention toothpaste dispenser device shown in FIG. I to illustrate the two one way valves and to show the male receiving inlet stem;

FIGS. 3 and 4 illustrate partial expanded cut side views of the present invention toothpaste dispenser device one way valves shown in FIGS. 1 and 2;

FIG. 5 illustrates a front view of the present invention toothpaste dispenser device one way valves and housing of FIGS. 3 and 4;

FIGS. 6 and 7 illustrate present invention toothpaste dispenser device inlet stem arrangements;

FIG. 8 shows a bottom view of the cover of the present invention device showing in FIG. 1; and, FIG. 9 illustrates a side view of an alternative embodiment present invention toothpaste dispenser device.

### DETAILED DESCRIPTION OF THE PRESENT INVENTION

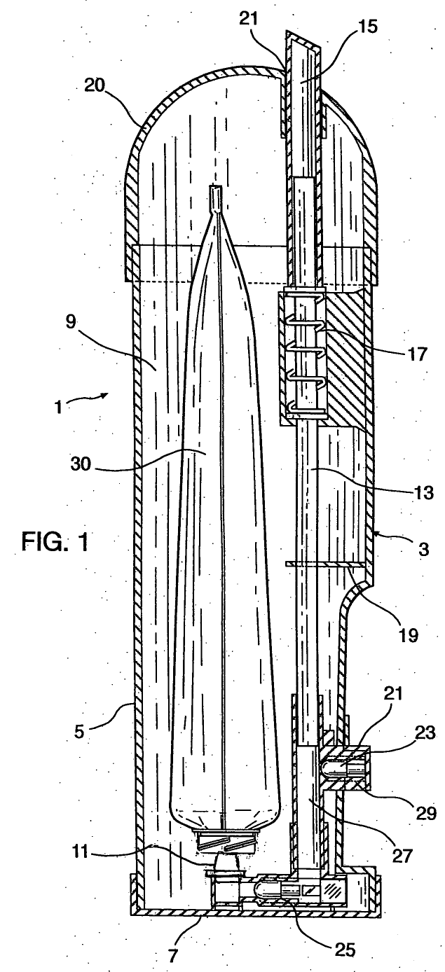

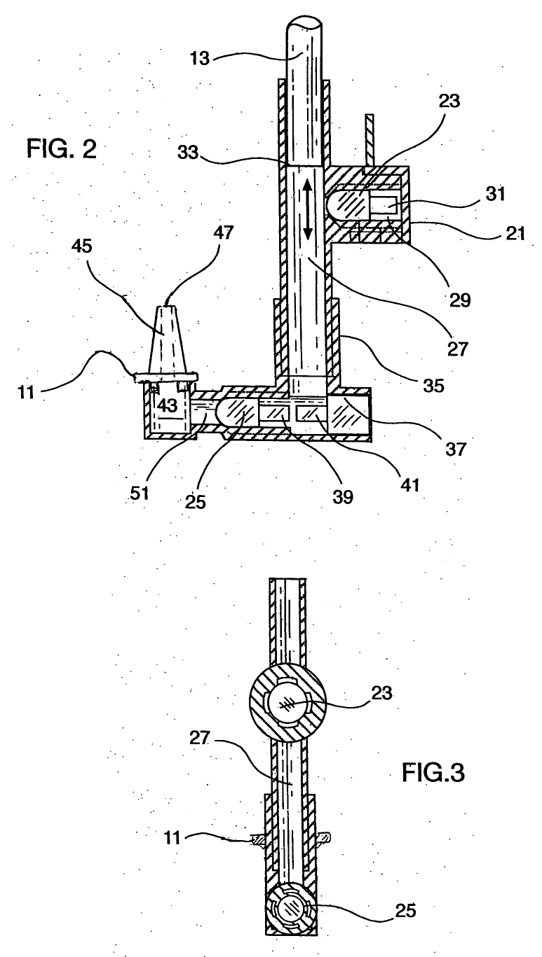

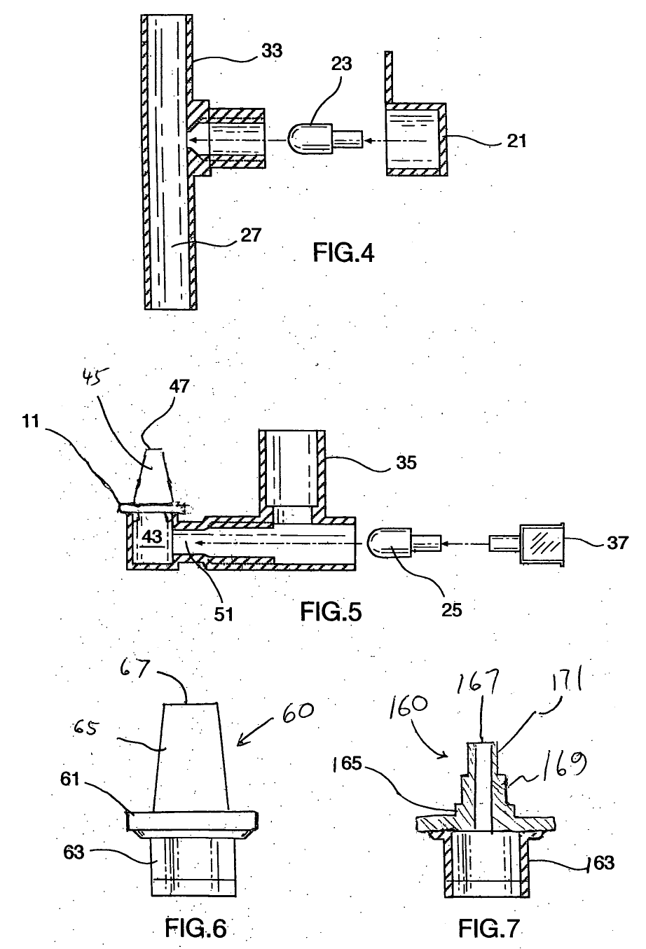

FIG. 1 illustrates a cut side view of a present invention toothpaste dispenser device shown as dispenser 1. FIG. 2 illustrates a partial detailed side cut front view of the present invention toothpaste dispenser device shown in FIG. 1, to illustrate the two one way valves. FIGS. 3 and 4 illustrate partial expanded cut side views of the present invention toothpaste dispenser 1 one way valves shown in FIGS. 1 and 2. FIG. 5 illustrates a front view of the present invention toothpaste dispenser device one way valves and housing of FIGS. 3 and 4, with identical components in all of the foregoing Figures identically numbered. These figures are now discussed collectively.

Toothpaste dispenser device 1 has an uprighted main housing base 3 with at least one side wall, in this case circular side wall 5, and flat bottom 7. The side wall (s) do not have to be circular, and could be rectangular, and square, hexagon, etc, or irregular shape and varied cross-sections. The bottom 7 is flat for placement on a counter or other flat surface, but could be any shape for those embodiments that are wall mounted or are nested in a support.

Main housing base 3 has an open top 9 for inserting a toothpaste tube into it. Tube 30 is pushed onto tube-receiving male inlet stem 11. Inlet stem 1I is fixed inside a bottom area of side wall 5. Details of this inlet stem 11, as well as the dispensing conduit, the one way valves and their connections are shown in FIGS. 2 through 5.

Spring biased push rod 13 and its extention 15 is biased upwardly by coil spring 17 and is held in position by orifice 21 in cover 20, by the coil spring 17 housing, by bracket 19 and by conduit 27. (Any workable support mechanism could be employed.) Push rod 13 is biased upwardly so it is above one way valve 23 located at outlet 29. A one way valve 25 is located at the bottom of conduit 27 near inlet stem 11 (referred to below as the inlet valve 25; inlet and outlet being used with respect to fluid flowing into and out of conduit 27.) Referring specifically to FIGS. 2 and 3, inlet stem 11 has an open top 47 a tapered sidewall 45 for receiving different inside diameter size tube necks and thus different volume tubes. There is also a fill basin 43, inlet conduit 45 and a fill conduit 51 that includes inlet one way valve 25 with stop heal 39 attached there to when push rod 13 is pushed down and then released, coil spring 17 forces push rod 13 back up, sucks one way valve 25 to the right against stop 41 of insert 37, and sucks paste or other material out of its tube through basin 43 and into conduit 27 to load up the device with paste. When push rod 13 is pushed down again, it pushes outlet one way valve 23 forward and pushes paste out through outlet orifice 29.

Although not required, it is preferred to have an outlet cover lid or cap for outlet orifice 29 to prevent or inhibit drying out or hardening of the paste that remains in conduit 27. In this embodiment, rotating cover 21 is used to open and close the outlet dispensing orifice 29 FIG. 3 shows a partial cut front view of the components shown in FIG. 2. FIGS. 4 and 5 show partial, exploded cut views of the upper and lower portions, respectively, of the components of FIGS. 2 and 3. Note that conduit 27 has and upper tube 33 and a lower female tube section 35 connecting to inlet conduit 51.

FIGS. 6 and 7 show side views, FIG. 6 full, FIG. 7 cut, of two different embodiments of inlet stems used in the present invention devices 60 and 160, respectively. Both are adapted to receive different size tubes with different size neck inside diameters. In FIG. 6, stem 60 includes tube rest flange 61 a tapered section 65 with an open top 67, with basin insert 63 at its bottom. The tapered section 65 has its smallest diameter at its top and largest diameter at its bottom, to accommodate any inside diameters between the two. In practice, a tube is opened and is pushed down onto the stem for a snug fit, i.e. until its inside coincides with the diameter of the stem. In FIG. 7, stem 160 includes tube rest flange 161 a step down section 165 with a plurality of different diameter rings to match up with predetermined i.d. tube necks. It has an open top 167, with basin insert 163 at its bottom. The step down section 165 has its smallest diameter at its top and largest diameter at its bottom, to accommodate any inside diameters between the two. In practice, a tube is opened and is pushed down onto the stem for a snug fit.

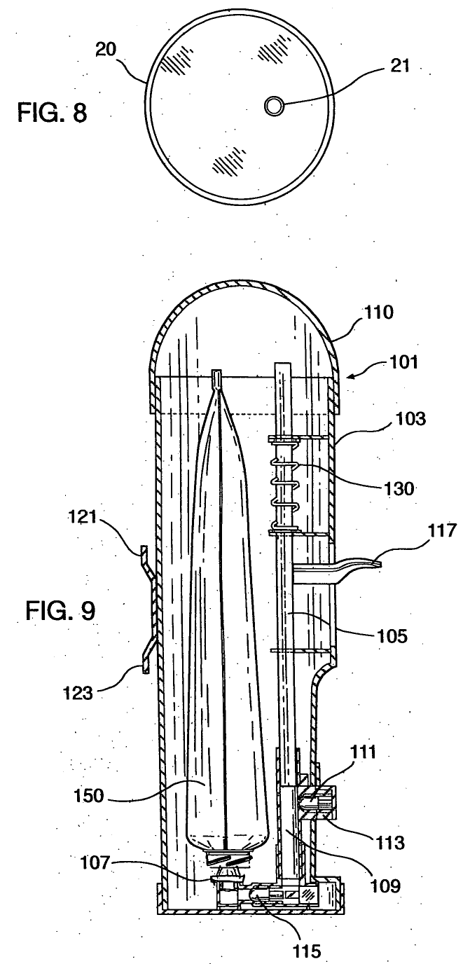

FIG. 8 shows a bottom view of cover 20 illustrating the offset position of push rod guide orifice 21.

FIG. 9 shows a side cut view of an alternative embodiment of a present invention device 101. Includes main housing 103, push rod 105, inlet fixture 107, conduct 109,and cover 110. There are two one way valves 111 and 115 that operate in conjunction with push rod 105 and dispensing orifice 113 in the same matter as described above except that push rod 105 is biased upwardly by spring 130 and is pushed downwardly with side lever 117. Also note that dispenser 101, further, dispenser 101 wall mounting bracket 121 and 123 and may be wall mounted or rested upon a horizontal surface.

Obviously, numerous modifications and variations of the present invention are possible in light of the above teachings. It is therefore understood that within the scope of the appended claims, the invention may be practiced otherwise than as specifically described herein.

What is claimed is:

1. A toothpaste dispenser device, which comprises:
(a) an upright elongated main housing base having a bottom and at least one side wall, and having and a tube insert opening for inserting a tube therein, and having a dispensing outlet located on said side wall;
(b) a male receiving inlet stem adapted for receiving the inside neck of an inverted, uncapped toothpaste tube thereon, said inlet stem being fixedly located in said main housing base and functionally connected to said dispensing outlet via a dispensing conduit;
(c) a cover for opening and closing said tube insert opening of said base;
(d) said dispensing conduit functionally connected to said inlet stem and to said outlet, and having a push rod orifice located thereon;
(e) a spring-biased push rod located in said conduit push rod orifice and extending therefrom to a point outside of said main housing base and cover, and having a spring biasing it to a rest position away from said inlet stem, said push rod having a downstroke and an upstroke, wherein said push rod may be pushed down in its downstroke against the bias of said spring to a maximum stress position, and released to move up by the force of said spring in an upstroke back to its rest position;
(f) a first one-way valve located in said conduit near said inlet stem that permits flow of toothpaste from a connected tube when said push rod is in an upstroke and prevents flow of toothpaste from said tube when said push rod is in its rest position or in its downstroke;
(g) a second one-way valve located in said conduit near said outlet that permits flow of toothpaste from said conduit through said outlet when said push rod is in a downstroke and prevents flow of toothpaste from said conduit when said push rod is in its rest position or in its upstroke.

2. The toothpaste dispenser device of claim 1 wherein said main housing base and said main housing cover have a closed position top view shape selected from the group consisting of a square, a polygon, a rectangle, a circle and an oval.

3. The toothpaste dispenser device of claim 1 wherein said push rod is positioned vertically and is at a right angle to said base bottom and said push rod extends through said cover.

4. The toothpaste dispenser device of claim 1 wherein said inlet stem has a plurality of different outside diameters in an increasing size with descending position arrangement so as to be capable of receiving a plurality of different size tube necks with corresponding different inside diameters.

5. The toothpaste dispenser device of claim 1 wherein said push rod has a top area for pushing downwardly thereon.

6. The toothpaste dispenser device of claim 4 wherein said push rod has a top area for pushing downwardly thereon.

7. The toothpaste dispenser device of claim 1 wherein said push rod has a side slider button for pushing downwardly thereon.

8. The toothpaste dispenser device of claim 1 wherein said dispensing outlet has a closing mechanism that is biased in a closed position and yields to open when toothpaste is being dispensed therefrom.

9. The toothpaste dispenser device of claim 1 wherein said main housing base includes a push rod guide located on an inside of its side wall to maintain said push rod in a single axis for its upstroke and downstroke movement.

10. The toothpaste dispenser device of claim 1 wherein said spring is a coil spring connected to said push rod at a first end and is fixedly attached to said base at a second end.

11. The toothpaste dispenser device of claim 4 wherein said inlet stem is tapered with a smallest diameter at its top of said taper and a largest diameter at its bottom of said taper.

12. The toothpaste dispenser device of claim 4 wherein said inlet stem includes a plurality of different diameter rings with a smallest diameter at its top of said taper and a largest diameter at its bottom of said taper.

13. A toothpaste dispenser device, which comprises:
(a) an upright elongated main housing base having a bottom and at least one side wall, and having and a tube insert opening for inserting a tube therein, and having a dispensing outlet located on said side wall;
(b) a male receiving inlet stem adapted for receiving the inside neck of an inverted, uncapped toothpaste tube thereon, said inlet stem being fixedly located in said main housing base and functionally connected to said dispensing outlet via a dispensing conduit, said inlet stem having a plurality of different outside diameters in an increasing size with descending position arrangement so as to be capable of receiving a plurality of different size tube necks with corresponding different inside diameters;
(c) a cover for opening and closing said tube insert opening of said base;
(d) said dispensing conduit functionally connected to said inlet stem and to said outlet, and having a push rod orifice located thereon;
(e) a spring-biased push rod located in said conduit push rod orifice and extending therefrom to a point outside of said main housing base and cover, and having a spring biasing it to a rest position away from said inlet stem, said push rod having a downstroke and an upstroke, wherein said push rod may be pushed down in its downstroke against the bias of said spring to a maximum stress position, and released to move up by the force of said spring in an upstroke back to its rest position;
(f) a first one-way valve located in said conduit near said inlet stem that permits flow of toothpaste from a connected tube when said push rod is in an upstroke and prevents flow of toothpaste from said tube when said push rod is in its rest position or in its downstroke;
(g) a second one-way valve located in said conduit near said outlet that permits flow of toothpaste from said conduit through said outlet when said push rod is in a downstroke and prevents flow of toothpaste from said conduit when said push rod is in its rest position or in its upstroke; and, (h) an uncapped tube of toothpaste screwed into said inlet.

14. The toothpaste dispenser device of claim 13 wherein said main housing base and said main housing cover have a closed position top view shape selected from the group consisting of a square, a polygon, a rectangle, a circle and an oval.

15. The toothpaste dispenser device of claim 13 wherein said push rod has a top area for pushing downwardly thereon.

16. The toothpaste dispenser device of claim 13 wherein said push rod has a side slider button for pushing downwardly thereon.

17. The toothpaste dispenser device of claim 13 wherein said dispensing outlet has a closing mechanism that is biased in a closed position and yields to open when toothpaste is being dispensed therefrom.

18. The toothpaste dispenser device of claim 13 wherein said main housing base includes a push rod guide located on an inside of its side wall to maintain said push rod in a single axis for its upstroke and downstroke movement.

19. The toothpaste dispenser device of claim 13 wherein said inlet stem is tapered with a smallest diameter at its top of said taper and a largest diameter at its bottom of said taper.

20. The toothpaste dispenser device of claim 13 wherein said inlet stem includes a plurality of different diameter rings with a smallest diameter at its top of said taper and a largest diameter at its bottom of said taper.
